(19) United States
(12) Patent Application Publication
(10) Pub. No.: US 2018/0046137 A1
(43) Pub. Date: Feb. 15, 2018

(54) IMAGE FORMING APPARATUS AND IMAGE FORMING CONTROL METHOD

(71) Applicants: KABUSHIKI KAISHA TOSHIBA, Tokyo (JP); TOSHIBA TEC KABUSHIKI KAISHA, Tokyo (JP)

(72) Inventor: Hisanobu Ajima, Yokohama Kanagawa (JP)

(21) Appl. No.: 15/460,507

(22) Filed: Mar. 16, 2017

(30) Foreign Application Priority Data
Aug. 10, 2016 (JP) 2016-158135
Mar. 10, 2017 (JP) 2017-46811

(51) Int. Cl. G03G 15/00

(52) U.S. Cl. CPC G03G 21/1875

(57) ABSTRACT

An image forming apparatus carries out control of an image forming operation by using the first image forming process parameter in a case in which the recording agent cartridge is not authenticated and is equivalent to the authenticated recording agent cartridge and also carries out control of an image forming operation by using the second image forming process parameter in a case in which the recording agent cartridge is not authenticated and is not equivalent to the authenticated recording agent cartridge.

### CROSS-REFERENCE TO RELATED APPLICATIONS

This application is based upon and claims the benefit of priority from Japanese Patent Application No. 2016-158135, filed Aug. 10, 2016 and Japanese Patent Application No. 2017-46811, filed Mar. 10, 2017, entire contents of which are incorporated herein by reference.

### FIELD

Embodiments described herein relate generally to an image forming apparatus and an image forming control method.

### BACKGROUND

Conventionally, an information recording medium such as an IC chip or a RFID tag is loaded in a recording agent cartridge that is used in an image forming apparatus in most cases. Information unique to the recording agent cartridge and information of use history of the recording agent cartridge are recorded in the information recording medium. In some image forming apparatus, a recording agent cartridge installed in the image forming apparatus is authenticated, and various kinds of information required for image formation are read out from the authenticated recording agent cartridge to carry out the image formation. In a case in which the authentication of the recording agent cartridge fails, the recording agent cartridge is treated as an unknown cartridge. In this case, a value unique to a recording agent included in the recording agent cartridge is not acquired. Thus, an image forming processing is executed with a general parameter stored in the image forming apparatus regardless of the type of the recording agent accommodated in the recording agent cartridge.

In recent years, a recording agent cartridge with no information recording medium is packaged with the image forming apparatus to be provided for a user at time of shipment from the point of view of cost reduction. Even if there is no information recording medium in the packaged recording agent cartridge, the image forming apparatus allows execution of formation of a predetermined number of images only if the recording agent cartridge is recognized the packaged one. However, since the packaged recording agent cartridge does not have the information recording medium, data for authentication does not have the information required for the image formation either. Thus, if the packaged cartridge is used in the image forming apparatus for reading out various kinds of information required for the image formation on the basis of an authentication result to carry out image formation control, the image formation can only be carried out with the general parameter stored at the main body side. Since the image forming processing corresponding to the type of the recording agent in such a recording agent cartridge is not carried out, there is a case in which inconvenience such as deterioration of image quality is caused.

### DESCRIPTION OF THE DRAWINGS

FIG. 1 is a perspective view illustrating an image forming apparatus according to an embodiment;

FIG. 2 is a diagram illustrating a constitution of main portion of the image forming apparatus according to the embodiment;

FIG. 3 is a block diagram illustrating a constitution of a control system of an image forming operation according to the embodiment;

FIG. 4 is a diagram illustrating table structures of a first memory and a second memory according to the embodiment;

FIG. 5 is a flowchart illustrating the image forming operation according to the embodiment; and

FIG. 6 is a flowchart illustrating the image forming operation according to the embodiment.

### DETAILED DESCRIPTION

In accordance with an embodiment, the image forming apparatus has an authentication section configured to authenticate an installed recording agent cartridge, a first image forming process parameter storage section configured to store a first image forming process parameter for controlling an image forming operation using the recording agent cartridge which is authenticated, a second image forming process parameter storage section configured to store a second image forming process parameter for controlling an image forming operation using the recording agent cartridge which is not authenticated, a determination section configured to determine whether or not the unauthenticated recording agent cartridge is equivalent to the authenticated recording agent cartridge; and an image forming control section configured to carry out control of an image forming operation by using the first image forming process parameter stored in the first image forming process parameter storage section in a case in which the recording agent cartridge is not authenticated by the authentication section and is determined to be equivalent to the authenticated recording agent cartridge by the determination section and to carry out control of an image forming operation by using the second image forming process parameter stored in the second image forming process parameter storage section in a case in which the recording agent cartridge is not authenticated by the authentication section and is determined not to be equivalent to the authenticated recording agent cartridge by the determination section

Hereinafter, an image forming apparatus and an image forming control method are described with reference to the accompanying drawings. “Decoloring” in the present embodiment refers to a processing of making an image formed with a color (containing not only chromatic colors but also achromatic colors such as white, black and the like) different from a base color of a sheet invisible visually.

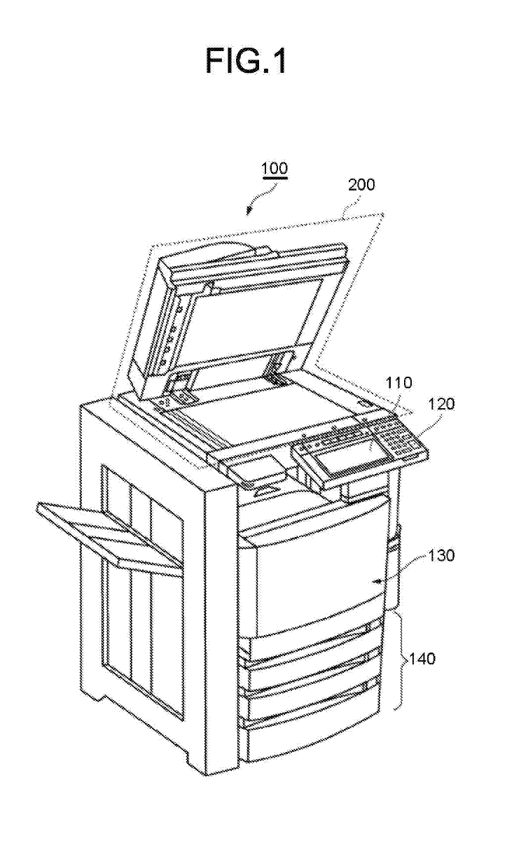

FIG. 1 is an external view illustrating an example of an entire constitution of an image forming apparatus 100 according to the embodiment. The image forming apparatus 100 is, for example, an MFP (Multi-Functional Peripheral). The image forming apparatus 100 is equipped with a display 110, a control panel 120, a printer section 130, a sheet housing section 140 and an image reading section 200. The printer section 130 of the image processing apparatus 100 maybe a device for fixing a toner image or an inkjet type device. Cartridges of toner and ink are collectively called a recording agent cartridge. Further, the recording agent cartridge also includes a recording agent cartridge in which either decoloring toner which can decolor a color later or toner which cannot decolor a color later is filled.

The image forming apparatus 100 forms an image on a sheet with a recording agent such as the toner. The sheet is, for example, a paper or a label paper. The sheet may be an optional sheet as long as the image forming apparatus 100 can form an image on the surface of the sheet.

The display 110 is an image display device such as a liquid crystal display, an organic EL (Electro Luminescence) display and the like. The display 110 displays various kinds of information relating to the image forming apparatus 100.

The control panel 120 includes a plurality of buttons. The control panel 120 receives an operation of a user. The control panel 120 outputs a signal corresponding to an operation carried out by the user to a control section of the image forming apparatus 100. Furthermore, the display 110 and the control panel 120 can be separate or both may be integrated into a single touch panel.

The printer section 130 forms an image on a sheet on the basis of image information generated by the image reading section 200 or image information received via a communication path. The printer section 130 forms the image with, for example, the following processing. The image forming section of the printer section 130 forms an electrostatic latent image on a photoconductive drum on the basis of the image information. The image forming section of the printer section 130 enables a recording agent to adhere to the electrostatic latent image to form a visible image. As a concrete example of the recording agent, toner is exemplified. The transfer section of the printer section 130 transfers the visible image on the sheet. The fixing section of the printer section 130 heats and pressures the sheet to enable the visible image to be fixed on the sheet.

The sheet on which the image is formed may be a sheet housed in the sheet housing section 140 or a manually fed sheet. The sheet housing section 140 houses a sheet used for the image formation by the printer section 130.

The image reading section 200 reads the image information of a read object as intensity of light. The image reading section 200 records the read image information. The recorded image information may be sent to another information processing apparatus via a network. The recorded image information may be used for the image formation on the sheet through the printer section 130.

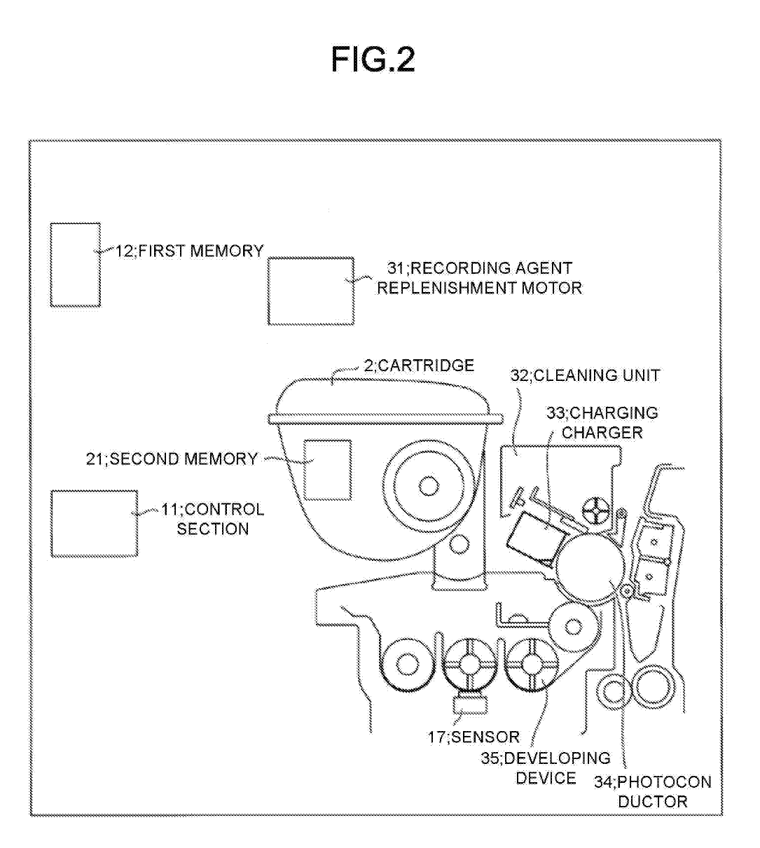

Next, a constitution of main portion of the image forming apparatus 100 shown in FIG. 1 is described with reference to FIG. 2. FIG. 2 is a diagram illustrating the constitution of main portion of the image forming apparatus 100. The main portion of the image forming apparatus 100 is equipped with a control section 11, a first memory 12, a sensor 17, a recording agent cartridge (hereinafter, referred to as a “cartridge”) 2, a second memory 21, a recording agent replenishment motor 31, a cleaning unit 32, a charging charger 33, a photoconductor 34 and a developing device 35.

The control section 11 collectively controls operations of the image forming apparatus 100. The first memory 12 is constituted as a nonvolatile memory, and stores information required for control of an image forming operation. The sensor 17 detects a density of a recording agent left in the developing device 35 of the image forming apparatus 100. The cartridge 2 is detachably constituted with respect to the image forming apparatus 100, and is filled with the recording agent. The second memory 21 is constituted as a nonvolatile memory, is arranged in the cartridge 2 and stores information required for control of an image forming operation suitable to the cartridge 2. The recording agent replenishment motor 31 is a motor for replenishing the recording agent accommodated in the cartridge 2. The cleaning unit 32 removes the recording agent adhering to the surface of the photoconductor 34. The charging charger 33 charges the surface of the photoconductor 34. The photoconductor 34 has a surface on which an image is formed with the recording agent. The developing device 35 is capable of storing the recording agent and supplies the recording agent to the photoconductor 34 through a developing roller.

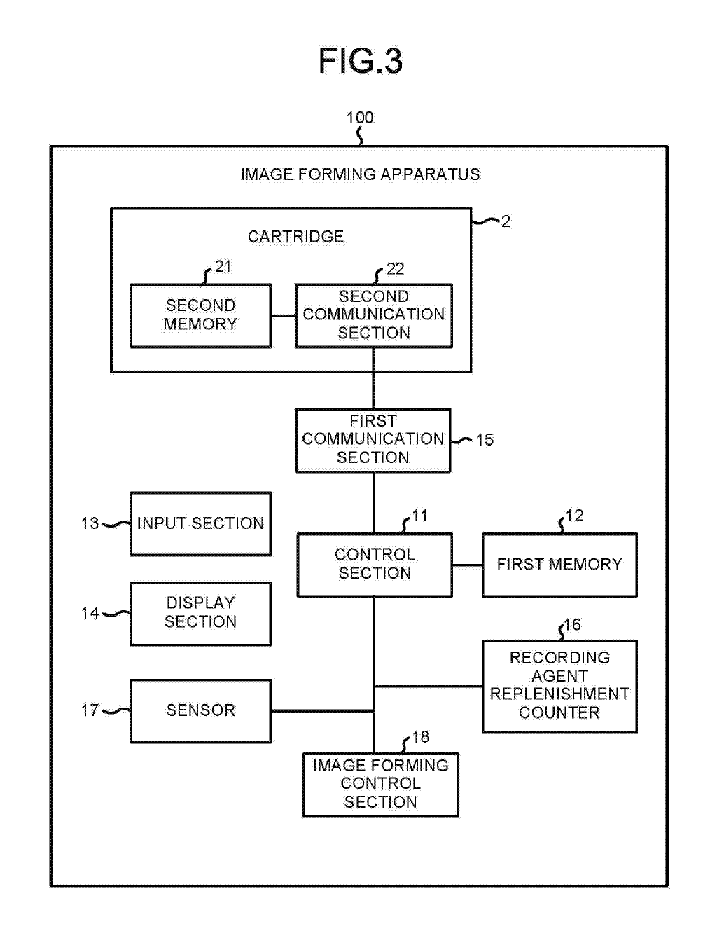

Next, a device constitution of a control system for controlling the image forming operation of the image forming apparatus 100 shown in FIG. 1 is described with reference to FIG. 3. FIG. 3 is a block diagram illustrating the device constitution of the control system for controlling the image forming operation of the image forming apparatus 100 shown in FIG. 1. The control section 11 collectively controls the operations of the image forming apparatus 100. The first memory 12 is constituted as the nonvolatile memory, and stores the information required for the control of the image forming operation. An input section 13 is equivalent to the control panel 120 shown in FIG. 1 and receives the operation of the user. The display section 14 is equivalent to the display 110 shown in FIG. 1 and displays various kinds of information relating to the image forming apparatus 100.

The first communication section 15 carries out information communication with the recording agent cartridge 2. A recording agent replenishment counter 16 counts the operations of the recording agent replenishment motor for rotating a screw arranged in the cartridge 2 to count a replenishment amount of the recording agent (toner or ink). The replenishment amount can be assumed to represent the number of times of the execution of the image formation or image forming execution amount. The sensor 17 detects the density of the recording agent left in the developing device 35 of the image forming apparatus 100. The control section 11 determines that the toner is empty on the basis of the detected density in a case in which the toner density does not rise no matter how many times the toner replenishment is carried out from the toner cartridge 2. An image forming control section 18 carries out the control of the image forming operation in the printer section 130 shown in FIG. 1.

The cartridge 2 is originally equipped with the second memory 21 that is nonvolatile and a second communication section 22. The cartridge 2 is detachably constituted with respect to the image forming apparatus 100. The second memory 21 stores the information required for the control of the image forming operation suitable to the cartridge 2. The second communication section 22 carries out information communication with the image forming apparatus 100. The communication carried out between the first communication section 15 and the second communication section 22 may be wired communication or wireless communication. However, in a case in which the communication is the wireless communication, the communication can be carried out only in a case in which the cartridge 2 is installed in the image forming apparatus 100.

Herein, the cartridge 2 is described. There are a plurality of types of cartridges 2 that can be used as the cartridges 2. One type of the cartridge 2 is equipped with the second memory 21, and another type of the cartridge 2 is not equipped with the second memory 21. The second memory 21 stores identification data for identifying the cartridge 2 and a process parameter data for an image formation which is readout by the image forming apparatus 100 at the time the cartridge 2 is used by the image forming apparatus 100.

The cartridge 2 having no second memory 21 is so-called non-recommended product. A recommended product is a product which is recommended to use with image forming apparatus 100 by the manufacture of the image forming apparatus 100.

However, there is a case in which the cartridge 2 with no second memory 21 is used as the recommended product, only if it is packaged with the image forming apparatus 100 for a shipment (Such a cartridge is called the packaged cartridge hereafter). This packaged cartridge 2 is not equipped with the second memory 21 from the point of view of cost reduction although it is the recommended cartridge.

Mutual authentication is carried out with the information of the identification data that are held in the memory 12 of the image forming apparatus 100 and in the memory 21 of the cartridge 2 side, and exchange of the data between the image forming apparatus 100 and the cartridge 2 is carried out.

Further, all the cartridge 2 having no second memory 21 should fail in the authentication. However, since the packaged cartridge 2 is the recommended cartridge, the packaged cartridge needs to pass the authentication to assure the most suitable image forming control. Therefore some measures are necessary to distinguish the packaged cartridge among all the cartridges 2 with no second memories 21.

The image forming apparatus 100 described herein carries out the control of the image forming operation by using a image forming process parameter fitting for recommended cartridge even if the packaged cartridge having no second memory is used.

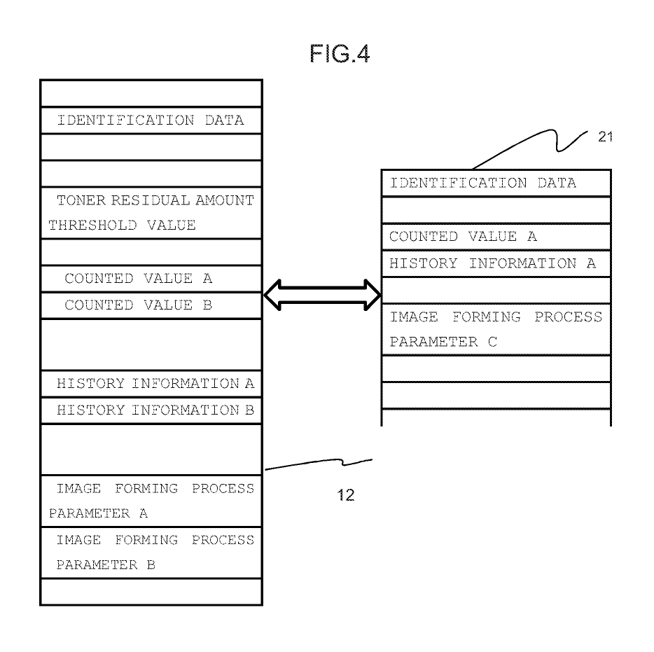

Next, information stored in the first memory 12 and the second memory 21 shown in FIG. 4 is explained.

The first memory 12 stores (1) an identification data for identifying the cartridge 2. Any specific data can be used as the identification data. The first memory 12 also has an area in which a toner residual amount threshold value is stored. This threshold value is set to allow the image forming apparatus 100 the predetermined amount of printing when the packaged cartridge is used in the image forming apparatus 100 the first memory 12 has also an area for storing a counted value A and counted value B which are the values counted by a recording agent replenishment motor counter shown in FIG. 3. The counted value A is counted when the recommended cartridge 2 is installed in the image forming apparatus 100. The counted value B is counted when the non-recommended cartridge 2 is installed in the image forming apparatus. The counted value A and counted value B are respectively stored in separate area in the first memory 12 based on the identification result based on the identification data. The control section 11 compares the counted value A with the toner residual amount threshold value stored in the first memory 12. The control section 11 compares the counted value B with the residual amount threshold value stored in the first memory 12.

The memory 12 is configured to be written history information A which shows if supplied toner amount form the recommended cartridge 2 had passed the threshold value stored in memory 12 or not based on the comparison result of the control section 11. The memory 12 is configured to be written history information B which shows if supplied toner amount form the non-recommended cartridge 2 had excessed the threshold value stored in memory 12 or not based on the comparison result of the control section 11. The history information A and the history information B are recorded as a flag comprising one or a few bit data to show if the supplied toner amount from the cartridge 2 surpassed the threshold value or not alternatively. A recording method of the history information A, B is not limited. Any method is available as long as it can show if the counted value A, B has surpassed the threshold value or not.

The first memory 12 has also stores process parameter data A and process parameter data B, which are respectively used for image forming in accordance with the property of the toner accommodated in the toner cartridge 2. Example of the process parameter data are charging bias voltage for an image photosensitive drum, light emitting power, or developing bias voltage and so on. These process parameter data can be set in accordance with print volume, the counted value of the rotational number of the motor 31 and environmental condition of the image forming apparatus 100 including environmental temperature or humidity.

The process parameter data A is used when the packaged cartridge 2 is used in the image forming apparatus 100. The process parameter data A is set according to lot number, manufacturing condition or characteristics of toner accommodated in the packaged cartridge 2.

The first memory 12 also stores another process parameter data B which is used for image forming with the toner accommodated in the non-recommended toner cartridge 2. In other words, another parameter data B is used when the identification fails.

The process parameter data B for the non-recommended toner cartridge 2 is different from the process parameter data A.

Next, the information stored in the second memory 21 is explained.

The second memory 21 stores an identification data for identifying the cartridge 2. The identification data stored in the second memory 21 is same as that stored in the first memory 12. The second memory 21 has an area for storing same value as the counted value A counted by the recording agent replenishment motor counter 16.

The second memory 21 also has an area for storing history information to show if the toner amount supplied from the recommended toner cartridge 2 has surpassed or not.

The second memory 21 stores a process parameter data C for the image forming. The process parameter data C is set according to lot number, manufacturing condition or characteristics of toner accommodated in the cartridge 2 with the second memory 21.

The process parameter data A, B, and C are respectively set to perform the image forming suitable to the toner accommodated in the respective toner cartridge 2. Therefore, the process parameter A and the process parameter C is set to be same when the property of the toner stored in the packaged cartridge 2 and toner that is stored in the cartridge 2 with the second memory 21 other than the packaged cartridge 2 is regarded as same. Further, a plurality of process parameter data C can be prepared according to the property of the toner and the selected process parameter data C can be stored in the second memory 21.

The counted value A and the history information A in the first memory 12 are reset each time a new cartridge 2 is installed in the image forming apparatus 100. The reset said herein means to delete information that shows the counted value A has surpassed the threshold value. As a result of the reset, the cartridge 2 installed in the image forming apparatus 100 is treated as the new cartridge.

On the other hand, the counted value B and history information B is never reset if the new cartridge 2 is installed in the image forming apparatus 100.

Next, control method of the first memory 12 and the second memory 21 is described. The identification data stored in the second memory 21 is compared with the identification data stored in the first memory 12 to carry out authentication when the cartridge 2 is installed in the image forming apparatus. The value the counter 16 counts up during a toner supply time is written in the first memory 12. However, the area for storing the value counter 16 counts up is different depending if the recommended cartridge or non-recommended cartridge is used in the image forming apparatus 100.

The stored data as same as counted value A in the second memory 21 is read out during a warming up operation after the power-ON or door opening/closing which implies a possibility that the toner is exchanged. The read data as the counted value A from the second memory 21 is written into first the memory 12.

On the other hand, when the cartridge 2 has finished the printing while the cartridge 2 is used in the image forming apparatus 100, the counted value A stored in the first memory 12 is read out and written in the memory 21 in the end of the printing job.

Further, when the counted value A stored in the first memory 12 has surpassed the residual amount threshold value stored in the first memory 12, the history information A is written into the first memory 12. The history information A is also read out and written into the second memory in the end of the printing job.

When the cartridge 2 that failed the authentication is used in the image forming apparatus 100, the counted value B is written in the first memory 12. If the counted value B has surpassed the residual amount threshold value stored in the first memory 12, the history information B is written into the first memory 12.

As to the process parameter data, when the authentication of the cartridge 2 has succeeded, the control section 11 of image forming apparatus 100 reads out the process parameter data C stored in the second memory 21 and uses it for the image forming. When the authentication of the cartridge 2 fails, the image forming apparatus 100 judges if the cartridge 2 is the packaged cartridge 2 or not. When the cartridge 2 satisfies the following both conditions, the cartridge 2 is judged as the packaged cartridge 2.
1. It failed the authentication.
2. The counted number B stored in the first memory 12 is less than the residual amount threshold value.

In other word, if the cartridge has no second memory 21 and the counted number B stored in the first memory 12 is more than the residual amount threshold value, that cartridge 2 in the image forming apparatus 100 is judged as the non-recommended cartridge 2. To the contrary, the cartridge 2 is not judged as the non-recommended cartridge even if the counted number B is less than the residual amount threshold value while the cartridge 2 has no second memory 21. In this case, the control section 11 judges the cartridge 2 in the image forming apparatus 100 as the packaged cartridge 2.

With this judgment by the control section 11, the packaged cartridge 2 is treated to be equivalent to the authenticated cartridge 2. Being equivalent to the authenticated cartridge 2 means that the cartridge 2 is allowed to be regarded as the authenticated cartridge 2 although the packaged cartridge 2 is not identical to the cartridge 2 with the second memory 21 in reality. When the cartridge 2 is judged to be the packaged cartridge 2, a procedure comprising reading the image forming process parameters and using them for the toner accommodated in the packaged cartridge 2 is determined by the control section 11. As a result, the control section 11 read out the process parameter data A stored in the first memory 12 when the cartridge 2 installed in the image forming apparatus 100 is judged is the packaged cartridge 2. The control section 11 read out the process parameter data B stored in the first memory 12 when the cartridge 2 installed in the image forming apparatus 100 is judged is the non-recommended cartridge 2. Which area in the first memory 12 the control section 11 accesses to is changed in accordance with the result of judging the type of the toner cartridge 2.

The controlling explained above means where to access to read out the image forming process parameter should be changed in accordance with the result of judging the type of the toner cartridge 2.

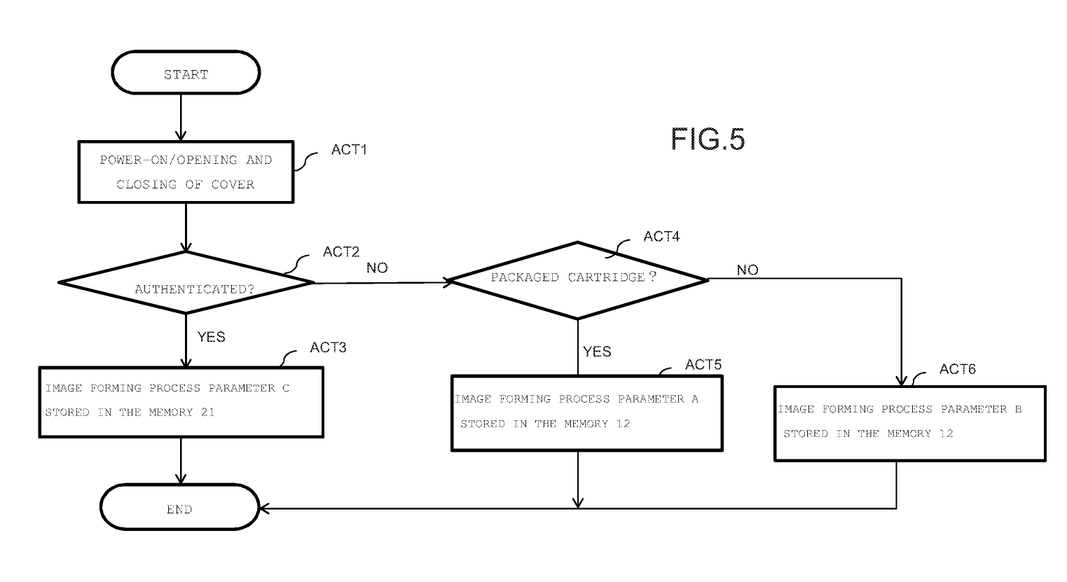

Next, with reference to FIG. 5, operations for controlling the image forming operation in the image forming apparatus 100 are described. FIG. 5 is a flowchart illustrating the operations for controlling the image forming operation in the image forming apparatus 100. At first, the control section 11 detects the power-ON of the image forming apparatus 100 or the opening and closing of the front door that is opened and closed at the time of the exchange of the toner (ACT 1). The control section 11 determines whether or not the authentication of the cartridge 2 can be carried out by carrying out the communication between the first communication section 15 and the second communication section 22 if the power-ON or the opening and closing of the door is detected (ACT 2). This authentication is carried out according to whether the identification data stored in the first memory 12 and in the second memory 21 are coincident.

Next, if the authentication can be carried out (YES in ACT 2), the control section 11 reads the process parameter data C stored in the second memory 21 (ACT 3). Further, the control section 11 writes the counted value A stored in the second memory 21 to the first memory 12. If the toner cartridge 2 is anew (unused) one, the counted value equals zero. The history information stored in the second memory 21 is also read out and the read out information is written into the first memory 12. The control section 11 finishes the warming up operation which is associated with possibility of an exchange of the cartridge 2.

On the other hand, if the authentication of the cartridge 2 fails (NO in ACT 2), the control section 11 determines whether or not the installed cartridge 2 is the packaged cartridge (ACT 4). This determination is carried out by the control section 11 according to whether the counted value B stored in the first memory 21 is more than the residual amount threshold value. When counted value B has not surpassed the residual amount threshold yet, the cartridge 2 installed in the image forming apparatus 100 is judged as the packaged cartridge (YES in ACT 4).

Subsequently, the control section 11 determines to use the process parameter data A stored in the first memory 12 to control the image forming operation (ACT 5). Then, the control section 11 ends the warming up operation carried out at the time of the opening and closing of the front cover which has a possibility that the toner is exchanged.

Next, in a case the cartridge 2 is considered not to be the packaged cartridge (NO in ACT 4), the control section 11 selects to use the image forming process data set B stored in the first memory 12 (ACT 6). Then, the control section 11 ends the warming up operation.

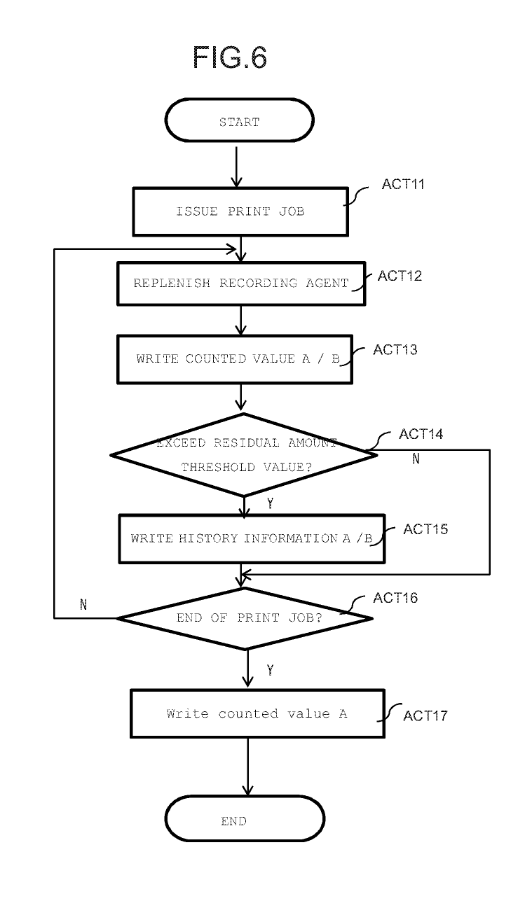

Next, with reference to FIG. 6, the operations of the image forming operation by the image forming apparatus 100 are described. FIG. 6 is a flowchart illustrating the operations in the image forming apparatus 100.

At first, if a print JOB occurs, the control section 11 issues the print JOB for the image forming control section 18 to instruct the execution of the print JOB (ACT 11).

In response to the instruction described above, the image forming control section 18 outputs an instruction for carrying out a replenishment operation of toner when the sensor 17 detects reduced concentration of the toner in the developing device (ACT 12).

At this time, the recording agent replenishment counter 16 counts recording agent replenishment amount based on the rotation number of the recording agent replenishment motor 31. The control section 11 writes the counted value A or the counted value B the counter 16 counts up into the first memory 12 (ACT 13).

Next, the control section 11 determines whether or not the counted value A or counted value B exceeds the residual amount threshold value on the basis of the number of counts of the recording agent replenishment counter 16 (ACT 14). As a result of this determination, if the count value exceeds the residual amount threshold value (YES in ACT 14), the control section 11 record the history information a or history information B in the first memory 12.

Next, the counted value A or the counted value B does not exceed the residual amount threshold value (NO in ACT 14), the control section 11 determines whether or not the image forming control section 18 carries out the image forming operation until the print JOB is ended, and notifies the control section 11 of the end of the print JOB at a point in time at which the image forming operation is ended. The control section 11 determines whether or not the print JOB is ended according to whether to receive the notification indicating the end of the print JOB from the image forming control section 18 (ACT 20). As a result of this determination, if the print JOB is not ended (NO in ACT 20), the control section 11 repeats the processing in ACT 12-ACT 16. On the other hand, if the print JOB is ended, the control section 11 writes counted number A stored in the first memory 12 into the second memory 21 if the authenticated cartridge is used, and ends the image forming operation (ACT 17).

In the above explanation, whether the cartridge 2 is the packaged cartridge 2 or not is determined based on the counted value A or the value B compared with the threshold. If it can be detected the cartridge 2 is empty, it is also acceptable to determine the type of the cartridge 2 based on the information that shows the cartridge 2 is already reached empty.

Further, the identification data stored in the first memory 12 and identification data stored in the second memory 21 is set to be identical so that the identification is carried out by confirming matching of these data in the above explanation. However, the identification method is not limited to this method. Any method is available as long as the identification is carried out by communicating between the first memory 12 provided in the image forming apparatus 100 and the second memory 21 provided on the cartridge 2. Mutual authentication system using encryption system such as public key encryption system or a private key encryption system is available.

Further to make the recording agent residual amount threshold reflected data that reflect the property of the recording agent accommodated in the cartridge 2 more correctly, the recording agent residual amount threshold can be stored in the second memory 21. In this case the recording agent residual amount stored in the second memory 21 is read out and read out data is written into the first memory 12 at the timing of power-on or opening/closing the door. By adding this step, same control as the image forming control explained above forming can be performed.

Part of functions of the image forming apparatus 100 of the embodiment described above may be realized by a computer. In this case, a program for realizing the function is recorded in a computer-readable information recording medium. Then, the program recorded in the information recording medium for recording the foregoing program is read into a computer system and may be realized by being executed. Furthermore, the “computer system” described herein includes hardware such as an operating system and a peripheral device. Further, the “computer-readable information recording medium” is referred to as a portable medium or a storage device. The portable medium is a flexible disk, a magneto-optical disk, a ROM, a CD-ROM and the like. The storage device is a hard disk built in the computer system.

Furthermore, the “computer-readable information recording medium” dynamically holds a program for a short time, such as a communication wire in a case of transmitting the program via a communication line. The communication line is a network such as the Internet, a telephone line and the like. Further, the “computer-readable information recording medium” may be a volatile memory inside the computer system serving as a server or a client. The volatile memory holds the program for a certain time. Further, the above-mentioned program may be a program for realizing part of the foregoing functions. Further, the above-mentioned program may be realized by combining with a program that is already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
an authentication section configured to authenticate an recording agent cartridge installed in the image forming apparatus;
a first image forming process parameter storage section configured to store a first image forming process parameter for controlling an image forming operation using the recording agent cartridge which is authenticated;
a second image forming process parameter storage section configured to store a second image forming process parameter for controlling an image forming operation that is different from the first image forming process parameter using the recording agent cartridge which is not authenticated;
a determination section configured to determine whether or not the unauthenticated recording agent cartridge is equivalent to the authenticated recording agent cartridge; and
an image forming control section configured to carry out control of an image forming operation by using the first image forming process parameter stored in the first image forming process parameter storage section in a case in which the recording agent cartridge is not authenticated by the authentication section and is determined to be equivalent to the authenticated recording agent cartridge by the determination section;
and to carry out control of an image forming operation by using the second image forming process parameter stored in the second image forming process parameter storage section in a case in which the recording agent cartridge is not authenticated by the authentication section and is determined not to be equivalent to the authenticated recording agent cartridge by the determination section.

2. The image forming apparatus according to claim 1, further comprising:
an image forming execution amount data storage section configured to store image forming execution amount data; and
a threshold data storage section configured to store threshold data for the image forming execution amount,
wherein the determination section judges that the unauthenticated recording agent cartridge is not equivalent to the authenticated recording agent cartridge when the image forming execution amount data stored in the storage section excesses the threshold.

3. The image forming apparatus according to claim 1, wherein the recording agent cartridge includes a first cartridge having a memory storing identification data and a third image forming process parameter in accordance with the recording agent accommodated in the recording agent cartridge and a second cartridge having no memory.

4. The image forming apparatus according to claim 3, the authentication section authenticate the recording agent cartridge based on the identification data stored in the memory.

5. The image forming apparatus according to claim 3, wherein the first image forming process parameter and the third image forming process parameter is different.

6. The image forming apparatus according to claim 3, wherein the first image forming process parameter and the third image forming process parameter is same.

7. The image forming apparatus according to claim 3, wherein the memory further stores the threshold data used by the determination section.

8. The image forming apparatus according to claim 1, wherein the first image forming process parameter and the second image forming process parameter is different.

9. The image forming apparatus according to claim 1, the determination section further configured to determine whether or not depletion of recording agent has occurred within the recording agent cartridge.

10. An image forming control method carried out by an image forming apparatus which comprises an authentication section configured to authenticate an installed recording agent cartridge, a first image forming process parameter storage section configured to store a first image forming process parameter for controlling an image forming operation using the recording agent cartridge which is authenticated, and a second image forming process parameter storage section configured to store a second image forming process parameter for controlling an image forming operation using the recording agent cartridge which is not authenticated, comprising:
determining whether or not the unauthenticated recording agent cartridge is equivalent to the authenticated recording agent cartridge;
carrying out control of an image forming operation by using the first image forming process parameter stored in the first image forming process parameter storage section in a case in which the recording agent cartridge is not authenticated by the authentication section and determined to be equivalent to the authenticated recording agent cartridge by the determination section; and
carrying out control of an image forming operation by using the second image forming process parameter stored in the second image forming process parameter storage section in a case in which the recording agent cartridge is not authenticated by the authentication section and the determined not to be equivalent to the authenticated recording agent cartridge by the determination section.

11. The image forming control method according to claim 10, wherein the image forming apparatus further comprised image forming execution amount data storage section configured to store image forming execution amount data, a threshold data storage section configured to store threshold data for the image forming execution amount and determining section to determine the unauthenticated recording agent cartridge is not equivalent to the authenticated recording agent cartridge when the image forming execution amount data stored in the storage section excesses the threshold.

12. The image forming control method according to claim 10, wherein
the recording agent cartridge includes a first cartridge having a memory storing identification data and a third image forming process parameter in accordance with the recording agent accommodated in the recording agent cartridge and a second cartridge having no memory.

13. The image forming control method according to claim 12, wherein
the authentication section authenticate the recording agent cartridge based on the identification data stored in the memory.

14. The image forming control method according to claim 10, wherein
the first image forming process parameter and the second image forming process parameter is different.

15. The image forming control method according to claim 12, wherein the first image forming process parameter and the third image forming process parameter is different.

16. The image forming control method according to claim 12, wherein the first image forming process parameter and the third image forming process parameter is same.

17. The image forming control method according to claim 12, wherein the memory further stores the threshold data used by the determination section.

18. The image forming control method according to claim 10, wherein the image forming apparatus determines whether or not depletion of recording agent has occurred within the recording agent cartridge.
